(19) United States
(12) Patent Application Publication
(10) Pub. No.: US 2008/0129965 A1
(43) Pub. Date: Jun. 5, 2008

(54) PROJECTOR

(75) Inventor: Masatoshi Yonekubo, Hara-mura (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/949,177

(22) Filed: Dec. 3, 2007

(30) Foreign Application Priority Data
Dec. 5, 2006 (JP) 2006-327890

(51) Int. Cl. G03B 21/20

(52) U.S. Cl. 353/85

(57) ABSTRACT

A projector includes a projection engine section for projecting light corresponding to an image signal toward an irradiated surface, a housing for housing the projection engine section, the housing including an emission section for projecting the light corresponding to the image signal from the projection engine section towards the irradiated surface, a detection section for detecting an entering matter entering at least a monitoring area on a side opposite to a side of an extended surface of the irradiated surface with respect to the emission section, and a control section for controlling intensity of light to be emitted from the emission section in accordance with a detection result of the detection section.

### BACKGROUND

1. Technical Field

The present invention relates to a technical field of a projector, and in particular to a technical field of a projector capable of close-up projection for projecting light from a position near the irradiated surface.

2. Related Art

Most of the projectors which have been in widespread use in the past are placed at positions rather distant from screens in order for assuring an appropriate projection distance. In the case in which the projector is placed at a position distant from the screen, it is required to provide a space where no obstacles for blocking the light exist in the light path between the projector and the screen. The larger the display screen becomes, the more remarkable such a restriction in the installation position of the projector becomes. In particular, in the case of a small room, projection of a large screen becomes difficult.

In recent years, a technology for performing close-up projection with a front projection projector has been proposed. By enabling the close-up projection, it becomes possible to place the projector at a position near, for example, a wall surface. By making it possible to place the projector at a position near the wall surface, for example, a position within several tens of centimeters from the wall surface, the restriction in the installation position of the projector can be eased, thus enabling space reduction. Further, display with a large screen becomes possible even in a small room.

In the case in which a high power light source such as a laser source is used in a projector, if a person enters an area where the intense light reaches, uncomfortable feeling may be exerted on the human body, in particular eyes of the person. In order for avoiding occurrence of such a case of exerting uncomfortable feeling, in the past, a technology of reducing intensity of a laser beam or stopping emission of the laser beam in response to a sensor detecting an entering matter has been proposed (e.g., see JP-T-11-501419 (the term “JP-T” as used herein means a published Japanese translation of a PCT patent application)). In order for detecting the entering matter moving towards the area where the laser beam reaches at an early stage, the area where the laser beam reaches and the periphery thereof are monitored by sensors.

However, in the case in which a person runs through in front of the screen, monitoring, for example, a peripheral area of the screen with 1 m width corresponding to about 10cm from the outer edge of the screen sometimes fails to sufficiently provide time for controlling the laser beam. If the time for controlling the laser beam is not provided, it is difficult to surely avoid occurrence of such a case as to exert uncomfortable feeling. If the monitoring area is expanded to a wider range for providing the time, for controlling the laser beam, a false operation caused by detecting a matter other than the entering matter may frequently occur. The frequent false operations hinder appreciation of an image. As described above, in the related art, it is problematically difficult to surely avoid occurrence of such a case as to exert uncomfortable feeling.

### SUMMARY

In view of the above problem, an advantage of some aspects of the invention is to provide a projector capable of surely avoiding occurrence of such a case as to exert uncomfortable feeling in projecting light.

According to an aspect of the invention, it is possible to provide a projector including a projection engine section for projecting light corresponding to an image signal toward an irradiated surface, a housing for housing the projection engine section, the housing including an emission section for projecting the light corresponding to the image signal from the projection engine section towards the irradiated surface, a detection section for detecting an entering matter entering at least a monitoring area on a side opposite to a side of an extended surface of the irradiated surface with respect to the emission section, and a control section for controlling intensity of light to be emitted from the emission section inaccordance with a detection result of the detection section.

In the case in which the close-up projection for projecting light obliquely from a position opposed to the extended surface of the irradiated surface is performed, the observer should observe the image from behind the projector. Further, by shortening the distance from the extended surface to the emission section, normally, a person and so on do not enter the projection area from the emission section to the irradiated surface. The detection section monitors the entering matter in an area on the side of the observer with respect, to the emission section to detect the entering matter approaching the projection area from behind the projector. Therefore, even if the case in which the projection area is looked into by chance occurs, the intensity of the light can be controlled prior to the entering matter reaching the projection area. By performing the control of decreasing the light intensity or stopping emission of the light prior to the entering matter reaching the projection area, occurrence of such a case as to exert uncomfortable feeling can surely be avoided. Thus, the projector capable of surely avoiding occurrence of such a case as to exert uncomfortable feeling can be obtained.

Further, in another preferable aspect of the invention, the projector is preferably disposed at a position where a distance from the extended surface to a center point of the emission section is no greater than 80 cm. The distance from the extended surface to the center point of the emission section is further preferably no greater than 60 cm, and most preferably in a range of 30 through 40 cm. According to the close-up projection in such a range, occurrence of the case in which a person and so on enters the projection area can drastically be reduced. Thus, occurrence of such a case as to exert uncomfortable feeling can more surely be avoided.

Further, in another preferable aspect of the invention, the detection section is preferably disposed on the surface of the housing on the side opposite to the side of the extended surface. Thus, it can be arranged that the entering matter entering the monitoring area behind the projector can be detected.

Further, in another preferable aspect of the invention, the emitting section is preferably disposed at the position shifted from the center of the housing to the side opposite to the side of the extended surface. Thus, the projection distance can be gained to allow the projector to be disposed at a position close to the extended surface.

Further, in another preferable aspect of the invention, the detection section preferably detects a variation in an electromagnetic radiation. Thus, entrance of the entering matter can be detected.

Further, in another preferable aspect of the invention, an electromagnetic radiation generation section for generating the electromagnetic radiation is preferably provided. Thus, the variation in the electromagnetic radiation can correctly be detected, and the entering matter can surely be detected.

Further, in another preferable aspect of the invention, the detection section preferably detects a distance from the detection section to the entering matter, and the control section preferably controls the intensity of the light to be emitted from the emission section in accordance with the distance from the detection section to the entering matter. It becomes possible to determine which one of the measure for avoiding such a case as to exert uncomfortable feeling and continuation of the image display should be performed with priority based on the distance from the detection section to the entering matter. Thus, occurrence of such a case as to exert uncomfortable feeling can be avoided while minimizing the influence on the image appreciation.

Further, in another preferable aspect of the invention, the detection section preferably includes a first detection section and a second detection section disposed at a different position from a position of the first detection section in a horizontal plane substantially perpendicular to the extended surface. By, for example, disposing the first detection section at the right end of the housing and the second detection section at the left end thereof, the monitoring area on either sides of the projector can be expanded. By thus expanding the monitoring area as described above, occurrence of such a case as to exert uncomfortable feeling can more surely be avoided.

Further, in another preferable aspect of the invention, the first detection section preferably monitors entrance of the entering matter in a first monitoring area, the second detection section preferably monitors entrance of the entering matter in a second monitoring area, and the first and second detection sections preferably have the first and second monitoring areas overlap each other in the vicinity of the emission section. The closer to the emission section the entering matter enters, the higher the probability of occurrence of such a case as to exert uncomfortable feeling becomes. By overlapping the monitoring areas in the vicinity of the emission section, it becomes to detect entrance of the entering matter into the area in the vicinity of the emission section with high accuracy. Thus, occurrence of such a case as to exert uncomfortable feeling can more surely be avoided.

Further, in another preferable aspect of the invention, the detection section preferably detects the entering matter entering the monitoring area on the side of the extended surface with respect to the emission section. By performing the monitoring not only in an area on the side opposite to the side of the extended surface with respect to the emission section but also in an area on the side of the extended surface, higher reliability can be obtained.

Further, in another preferable aspect of the invention, the detection section preferably includes a first detection section for detecting the entering matter on the side opposite to the side of the extended surface with respect to the emission section and a second detection section for detecting the entering matter in the side of the extended surface with respect to the emission section. Thus, it can be arranged that both of the areas on the side opposite to the side of the extended surface and on the side of the extended surface with respect to the emission section can be monitored. Further, by overlapping the monitoring areas of both of the detection sections in the vicinity of the emission section, occurrence of such a case as to exert uncomfortable feeling can further surely be avoided.

Further, in another preferable aspect of the invention, the detection section preferably monitors entrance of the entering matter only in an area on the side opposite to the side of the extended surface with respect to the emission section. The shorter the distance from the extended surface to the emission section is, the lower the possibility of entrance of a person and so on into the projection area becomes. By monitoring entrance of the entering matter only in the area on the side opposite to the side of the extended surface, the configuration thereof can be simplified. Further, false operations caused, by the heat provided by the light in the projection area can also be drastically reduced. Thus, the simple configuration can be adopted, and an accurate operation for avoiding such a case as to exert, uncomfortable feeling becomes possible,

### BRIEF DESCRIPTION OF THE DRAWINGS

The invention will be described with reference to the accompanying drawings, wherein like numbers reference like elements.

FIG. 1 is a diagram showing a schematic configuration of a projector according to a first embodiment of the invention.

FIG. 2 is a diagram showing a schematic configuration of an optical engine.

FIG. 3 is a diagram schematically showing an optical system of a projection engine section,

FIG. 4 is a diagram showing a simulation of the behavior of the light modulated in accordance with an image signal.

FIG. 5 is a diagram showing a simulation of the behavior of the light modulated in accordance with an image signal.

FIG. 6 is a diagram for explaining detection of an entering matter by a detection section.

FIG. 7 is a diagram showing a block configuration for controlling the intensity of light.

FIG. 8 is a diagram showing a configuration of making a part of the projection engine section protrude from a housing.

FIG. 9 is a diagram showing a configuration of providing an infrared light source.

FIG. 10 is a diagram showing a perspective configuration of a projector according to a second embodiment of the invention.

FIG. 11 is a diagram for explaining a first monitoring area and a second monitoring area.

FIG. 12 is a diagram showing a perspective configuration of a projector according to a modified example of the second embodiment.

FIG. 13 is a diagram for explaining a first monitoring area and a second monitoring area.

FIG. 14 is a diagram for explaining a projector according to a third embodiment of the invention.

### DESCRIPTION OF EXEMPLARY EMBODIMENTS

Hereinafter, embodiments of the invention will be described in detail with reference to the accompanying drawings.

### First Embodiment

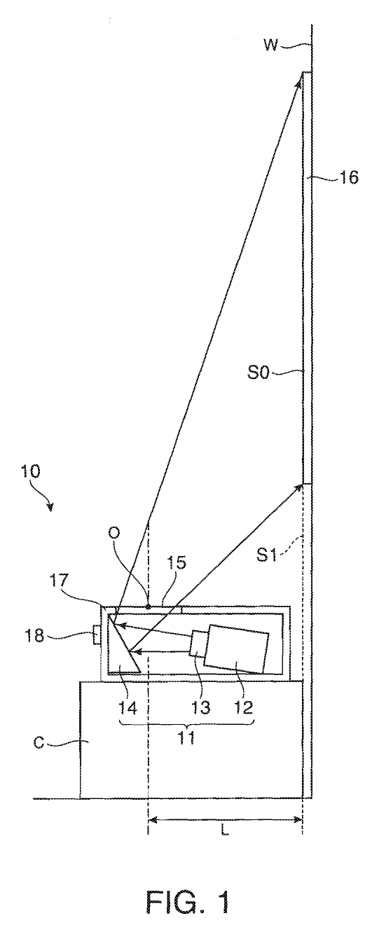

FIG. 1 shows a schematic configuration of a projector 10 according to a first embodiment of the invention. The projector 10 is a front projection projector for projecting light corresponding to an image signal. The projector 10 is disposed at a position, which is on a cabinet C disposed near the wall surface W, and is opposed to an extended surface S1 of an irradiated surface S0. The projector 10 performs close-up projection from a position near the extended surface S1. The projector 10 is provided with a projection engine section 11. The projection engine section 11 projects the light modulated in accordance with the image signal from the position opposed to the extended surface S1 to the irradiated surface S0. The projection engine section 11 is provided with an optical engine 12, a projection lens 13, and an aspherical mirror 14.

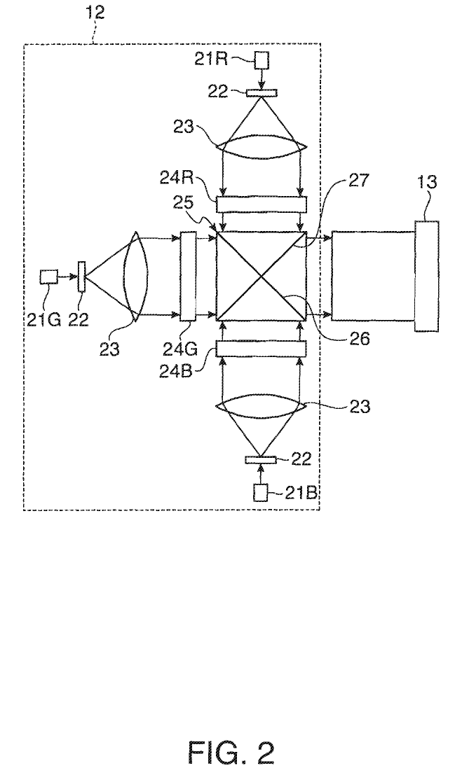

FIG. 2 shows a schematic configuration of the optical engine 12. A red (R) light source section 21R is a light source section for supplying R light, and a semiconductor laser for supplying a laser beam. A diffractive optical element 22 diffracts the laser beam, thereby fairing and enlarging the irradiated area. Further, the diffractive optical element 22 also equalizes intensity distribution of the laser beam. As the diffractive optical element 22, for example, a computer generated, hologram (CGH) can be used. The R light from the diffractive optical element 22 enters an R light spatial light modulation device 24R after being collimated by a collimator lens 23. The R light spatial light modulation device 24R is a spatial light modulation device for modulating the R light in accordance with the image signal, and is a transmissive liquid crystal display device. The R light modulated by the R light spatial light modulation device 24R enters a cross dichroic prism 25 as a color composition optical system.

A green (G) light source section 21G is a light source section for supplying G light, and a semiconductor laser for supplying a laser beam. The G light from the diffractive optical element 22 enters a G light spatial light modulation device 24G after being collimated by a collimator lens 23. The G light spatial light modulation device 2 4G is a spatial light modulation device for modulating the G light in accordance with the image signal, and is a transmissive liquid crystal display device. The G light modulated by the G light spatial light modulation device 24G enters the cross dichroic prism 25 from a different side from the R light.

A blue (B) light source section 21B is a light source section for supplying B light, and a semiconductor laser for supplying a laser beam. The B light from the diffractive optical element 22 enters a B light spatial light modulation device 24B after being collimated by a collimator lens 23. The B light spatial light modulation device 2 4B is a spatial light modulation device for modulating the B light in accordance with the image signal, and is a transmissive liquid crystal display device. The B light modulated by the B light spatial light modulation device 24B enters the cross dichroic prism 25 from a different side from the R light and the G light.

As each of the colored light source sections 21R, 21G, and 21B, besides the semiconductor laser, a diode pumped solid-state (DPSS) laser, a solid-state laser, a liquid laser, a gas laser, and so on can be used. Each of the colored light source sections 21R, 21G, and 21B can be provided with a wavelength conversion element for converting the wavelength of the laser beam such as a second-harmonic generation (SHG) element. As the transmissive liquid crystal display device, for example, a high temperature polysilicon TFT liquid crystal panel (HTPS) can be used.

The cross dichroic prism 25 is provided with two dichroic films 26, 27 disposed so as to be substantially perpendicular to each other. The first dichroic film 26 reflects the R light and transmits the G light and the B light. The second dichroic film 27 reflects the B light and transmits the R light and the G light. The cross dichroic prism 25 combines the R, G, and B light entering from the sides different from each other to emit the combined light in the direction towards the projection lens 13. The projection lens 13 projects the light combined by the cross dichroic prism 25.

The optical engine 12 is not limited to the case in which the transmissive liquid crystal display device is used as the spatial light modulation device. As the spatial light modulation device, a reflective liquid crystal display device (liquid crystal on silicon; LCOS), a digital micromirror device (DMD), a grating light valve (GLV), and so on can also be used. The projector 10 is not limited to having a configuration provided with the spatial light modulation device for every colored light beam. The projector 10 can be arranged to have a configuration of modulating two or more colored light beams by a single spatial light modulation device.

Going back to FIG. 1, the aspherical mirror 14 is disposed at a position opposed to the projection lens 13. The aspherical mirror 14 is an angle widening reflection section for making the light from the projection lens 13 wide-angle by reflection, and has a curved surface having an aspheric shape. The aspherical mirror 14 has a function of making the light from the projection lens 13 wide-angle, and a function of folding the light from the projection lens 13 to proceed in the direction towards the screen 16. The aspherical mirror 14 can be composed by forming a reflective film on a substrate including, for example, a resin member. As the reflective film, a layer of a highly reflective member, a layer of a metal member such as aluminum, a dielectric multilayer film, and so on can be used. Further, it is also possible to form a protective film including a transparent member on the reflective film.

The aspherical mirror 14 provided with a curved shape can fold the light and make the light wide-angle simultaneously. By making the light wide-angle not only by the projection lens 13 but also by the aspherical mirror 14, the projection lens 13 can be decreased in size compared to the case in which the light is made wide-angle only by the projection lens 13. The projection lens 13 and the aspherical mirror 14 enlarge the image and form the image on the irradiated surface S0. The projection lens 13 carries out the function of enlarging the image and forming the image on the screen 16. The aspherical mirror 14 carries out the function of enlarging the image. The aspherical mirror 14 can appropriately be changed in shape so as to correct the distortion of the image.

A housing 17 houses the projection engine section 11. An emission section 15 emits the light modulated in accordance with the image signal from the housing 17 towards the irradiated surface S0. The emission section 15 is formed by covering an opening provided to the housing 17 with a transparent member. On the surface of the housing 17 on the side opposite to the extended surface S1, there is provided a detection section 18. The screen 16 is a reflective screen for reflecting the light from the projection engine section 11. The screen 16 is arranged to be able to diffuse the light in a desired range where an observer exists, thus a preferable viewing angle characteristic can be provided.

The projector 10 is disposed so that a distance L from the extended surface S1 to the center point 0 of the emission section 15 is about 30 cm. The emission section 15 is disposed at a position shifted from the center of the housing 17 in a direction towards the side opposite to the side of the extended surface S1. Thus, the projection distance can be gained to allow the projector 10 to be disposed at a position near the extended surface S1. The projector 10 can be placed on, for example, the floor, a desk, or a rack besides the cabinet C. Since the projector 10 has a compact configuration, the installation place therefor can easily be assured. By arranging the projector 10 to be able to be placed adjacent, to the wall surface W, a large screen can be displayed even in a small room.

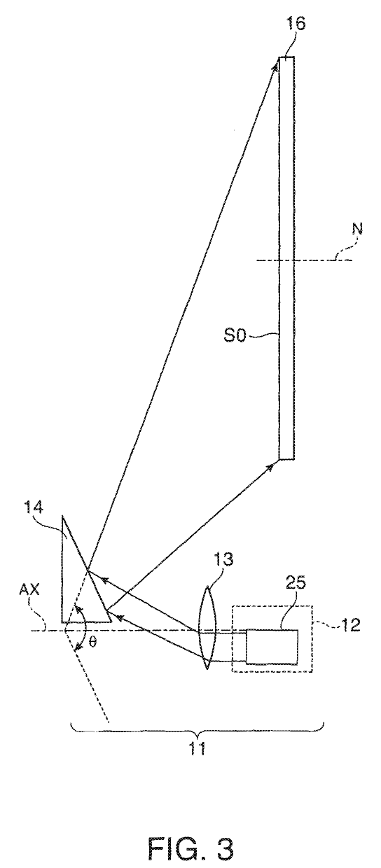

FIG. 3 is a diagram schematically showing the optical system of the projection engine section 11. The projection lens 13 and the aspherical mirror 14 are disposed so as to have the optical axes substantially identical to each other. The normal line N of the screen 16 is substantially parallel to the optical axis of the projection lens 13 and the optical axis of the aspherical mirror 14. The projection lens 13 and the aspherical mirror 14 form a so-called coaxial optical system in which both of them have a common optical axis AX. Further, the projection lens 13 and the aspherical mirror 14 form a so-called shift optical system for making the light modulated in accordance with the image signal proceed while being shifted to a specific side from the optical axis AX.

Specifically, it makes the light modulated in accordance with the image signal proceed while being shifted towards a specific side from the optical axis AX, namely the upper side of the sheet of FIG. 3. On the other hand, a central normal line of the field formed as a virtual field on the exit surface of the cross dichroic prism 25 in the optical engine 12 is parallel to the optical axis AX, and is shifted to the opposite side to the specific side, namely towards the lower side of the sheet of FIG. 3 from the optical axis AX. According to such a configuration, the projection engine section 11 makes the light with a large incident angle enter the screen 16. The incident angle is defined as an angle formed between the normal line N of the screen 16 and the incident light beam.

By adopting the coaxial optical system, a normal design approach for the coaxial system can be adopted. Therefore, it becomes possible to reduce the design manpower and to realize an optical system with reduced aberration. The aspherical mirror 14 can be formed to have a shape of substantially rotational symmetry about the optical axis AX, for example, a shape obtained by cutting out a part excluding the apex section from a cone. By forming the aspherical mirror 14 to have the shape roughly rotationally symmetrical about the optical axis AX, the optical axis of the aspherical mirror 14 and the optical axes of other components can easily be made identical. Since the aspherical mirror 14 has an axisymmetric aspheric shape, it can be processed by a simple method such as shaping on a lathe. Therefore, the aspherical mirror 14 can easily be manufactured with a high accuracy.

The projector 10 provided with the projection lens 13 and the aspherical mirror 14 adopts a super wide-angle optical system with a field angle ♭ of at least no less than 150 degrees, for example, 160 degrees. Further, by adopting the shift optical system, which uses only a part of the angle range of the supper wide-angle light, the traveling directions of the light beams can be uniformed. In the case of the present embodiment, for example, the minimum incident angle in the screen 16 is 70 degrees and the maximum incident angle therein is 80 degrees. By adopting the shift optical system, the difference in the incident angle among the incident light beams to the screen 16 can be controlled to be no greater than about 10 degrees.

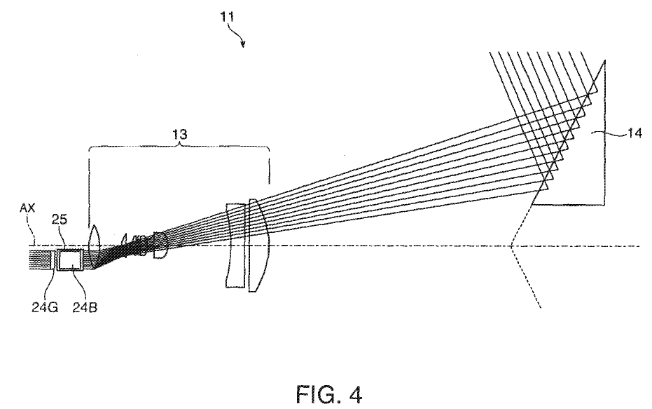

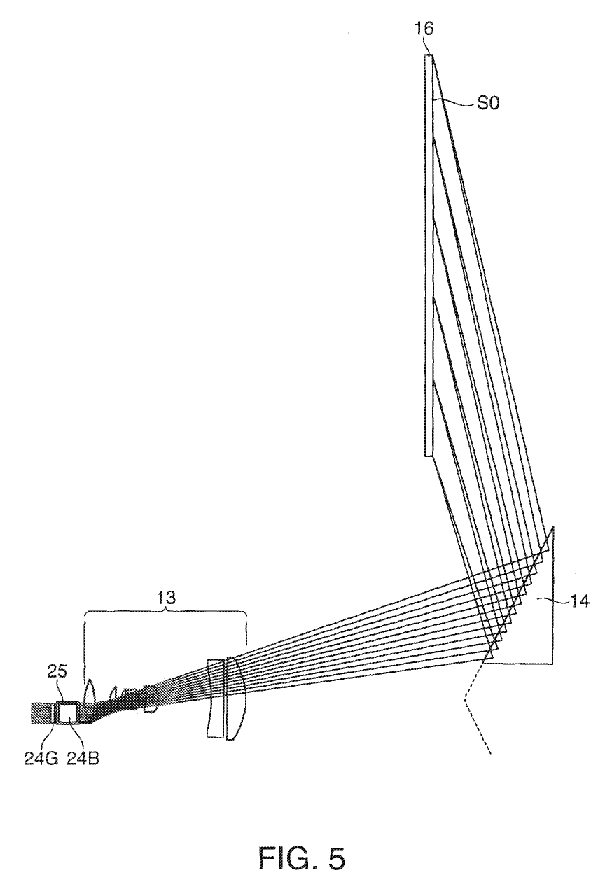

FIGS. 4 and 5 are diagrams showing a simulation of the behavior of the light modulated in accordance with the image signal. By shifting each of the spatial light modulation devices 24G, 24B, and 24R (not shown and disposed behind the cross dichroic prism 25) perpendicularly from the optical axis AX, the shift optical system is realized. As shown in FIG. 5, the projection lens 13 forms an image on the irradiated surface S0 with the light passed through the aspherical mirror 14. It should be noted that the configuration of the projection lens 13 is not limited to what is explained in the present embodiment, but any configurations can be adopted providing the supper wide-angle light can be obtained by the configurations.

The projection engine section 11 can be provided with a mirror for folding the light path between the projection lens 13 and the aspherical mirror 14. In the case in which the configuration of folding the light path by about 90 degrees by the mirror is adopted, the optical engine 12 and the projection lens 13 are disposed so as to emit light in the vertical direction of the sheet of FIG. 1 or the depth direction of the sheet thereof. Thus, it becomes possible to dispose the projection engine section 11 nearer the extended surface S1, and to decrease the distance L from the extended surface S1 to the center point O of the emission section 15.

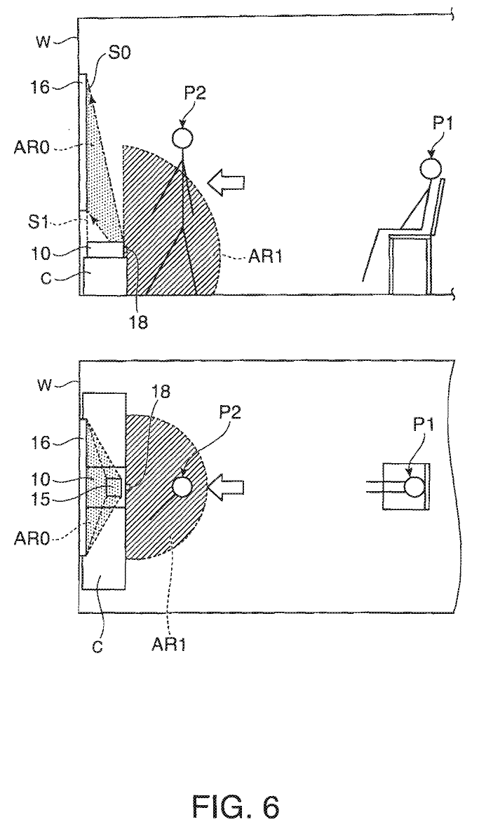

FIG. 6 is a diagram for explaining detection of an entering matter by the detection section 18, and shows a side configuration and a top configuration of a room in which the projector 10 is observed. Since the projector 10 performs the close-up projection from a position near the wall surface W, the observer P1 observes the image at a position behind the projector 10 and rather distant from the wall surface W. Further, in the case of the close-up projection with the distance of 30 cm from the extended surface S1 and the emission section 15, no person normally enters a projection area AR0 from the emission section 15 to the irradiated surface S0. However, in, for example, the case in which a person looks into the emission section 15 from behind the cabinet C, it is possible that uncomfortable feeling is exerted on a human body by receiving the intense light in the projection area AR0.

The detection section 18 detects an entering matter entering a monitoring area AR1 on the side of the observer P1, the opposite side to the side of the extended surface S1 with respect to the emission section 15. The detection section 18 is a so-called human sensor, the infrared sensor for detecting an infrared ray. The detection section 18 detects the time rate variation of the infrared ray as electromagnetic radiation, thereby detecting the entering matter. The monitoring area AR1 is a spatial domain having a shape similar to a hemisphere formed by cutting a sphere centered on the detection section 18 by a plane parallel to the irradiated surface S0. The range of the monitoring area AR1 is set based on the directivity provided to the detection section 18.

In the present embodiment, the detection section 18 monitors entrance of an entering matter only to the monitoring area AR1 on the side opposite to the side of the extended surface S1 with respect to the emission section 15. It is assumed, for example, that a footer P2 proceeds along the outline arrow from the observer P1 towards the projector 10 to enter the monitoring area AR1. The detection section 18 detects a variation in the infrared ray distribution caused by the entrance of the footer P2 as the entering matter to the monitoring area AR1. The monitoring area AR1 is set to be an area within 50 cm, preferably 1 m, from the emission section 15 in a direction towards the side opposite to the side of the extended surface S1. By setting the monitoring area AR1 with such a range, the time from when the entering matter enters to when the light is controlled can sufficiently be provided.

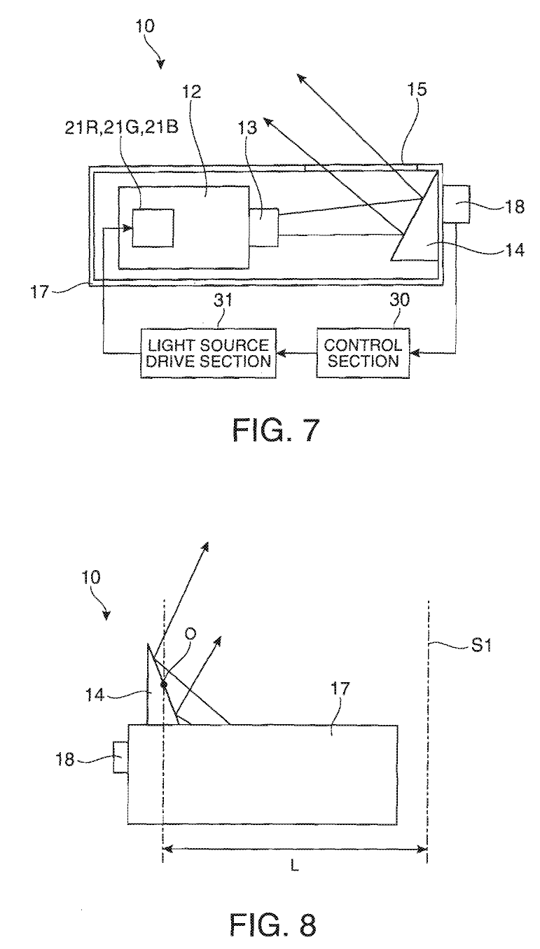

FIG. 7 shows a block configuration for controlling the intensity of light. The detection result by the detection section 18 is input to a control section 30. The control section 30 controls a light source drive section 31 in response to the detection result from the detection section 18 indicating that the infrared ray has varied. The light source drive section 31 makes the intensity of each of the colored light source sections 21R, 21G, and 21B decrease in accordance with the control by the control section 30. The light source drive section 31 makes the intensity of the light from the optical engine 12 decrease to the extent that the light will not exert uncomfortable feeling on the human body in the projection area AR0. As described above, the control section 30 controls the intensity of the light from the optical engine 12 in accordance with the detection result by the detection section 18.

In this way, even if the case in which the projection area AR0 is looked into by chance occurs, the projector 10 can control the intensity of the light prior to the entering matter reaching the emission section 15. By performing the control for decreasing the intensity of the light prior to the entering matter reaching the projection area AR0, occurrence of such a case as to exert uncomfortable feeling can surely be avoided. Thus, the advantage that occurrence of such a case as to exert uncomfortable feeling can surely be avoided is obtained.

By performing the close-up projection with the distance L (see FIG. 1) of about 30 cm from the extended surface S1 to the center point O of the emission section 15, the projector 10 can drastically reduce the occurrence of the case in which a person and so on enters the projection area AR0. It should be noted that the distance L from the extended surface S1 to the center point O of the emission section 15 can be set to at least no larger than 60 cm, and appropriately in a range of about 30 through 40 cm. By providing the configuration of monitoring entrance of an entering matter only to the monitoring area AR1 on the side opposite to the side of the extended surface S1 with respect to the emission section 15, the configuration of the projector 10 can be simplified. Further, false operations caused by conduction of the heat from the light in the projection area AR0 can also be reduced considerably. Thus, the simple configuration can be adopted, and an accurate operation for avoiding such a case as to exert uncomfortable feeling becomes possible.

The configuration of the projector 10 is not limited to what has the projection engine section 11 housed completely inside the housing 17. For example, as shown in FIG. 8, a part of the projection engine section 11 such as the aspherical mirror 14 can be protruded from the housing 17. The housing 17 is provided with an opening for transmitting the light entering the aspherical mirror 14. In this case, the aspherical mirror 14 functions as the emission section for emitting the light modulated in accordance with the image signal from the housing 17 towards the irradiated surface S0. The center point O in the aspherical mirror 14 corresponds to the center location of the reflection surface of the aspherical mirror 14 in the direction towards the extended surface S1.

The control section 30 is not limited to the case of making the intensity of each of the colored light source sections 21R, 21G, and 21B decrease by controlling the light source drive section 31. The control section 30 is only required to control, in accordance with the detection result by the detection section 18, the intensity of the light emitted from the emission section 15. For example, the control section 30 can be arranged to stop supplying the light from each of the colored light source sections 21R, 21G, and 21B by controlling the light source drive section 31. In the case of stopping supplying the light from each of the colored light source sections 21R, 21G, and 21B, it can also be arranged that control for putting off the light source is performed instead of the control of the light source drive section 31. Further, the control section 30 can also be arranged to stop emitting the light from the emission section 15 by controlling a structure for blocking the light in the light path from each of the colored light source, sections 21R, 21G, and 21B to the emission section 15.

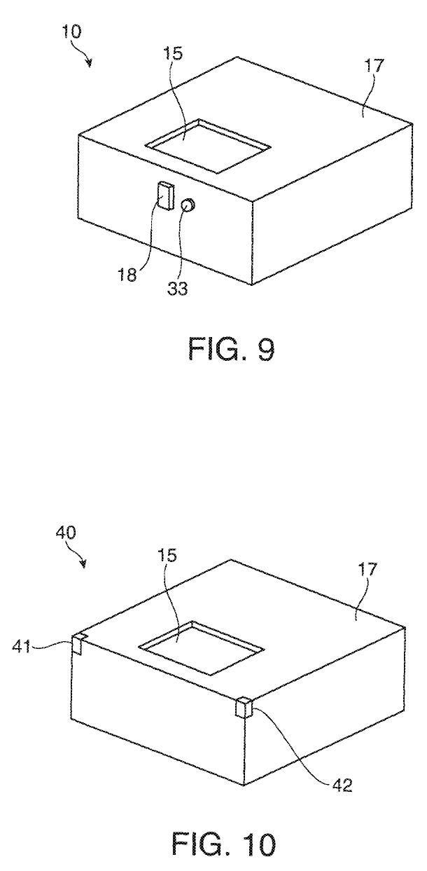

As shown in FIG. 9, the projector 10 can be provided with an infrared light source 33. The infrared light source 33 is an electromagnetic radiation generation section for generating an infrared ray as electromagnetic radiation. As the infrared light source 33, a light emitting diode element (LED) can be used, for example. The infrared light source 33 is disposed on the surface of the housing 17 and in the vicinity of the detection section 18. The infrared light source 33 supplies an infrared ray inside an area substantially the same as the monitoring area AR1 (see FIG. 6) of the detection section 18. The detection section 18 detects the variation in the infrared ray distribution taking the condition of detecting only the infrared ray from the infrared light source 33 as a reference. Thus, the variation in the infrared x-ay can correctly be detected, and the entering matter can surely be detected. It should be noted that the position of the infrared light source 33 is not limited to what, is shown in the drawing, and is required only to be able to supply the infrared ray to be the reference of the detection by the detection section 18.

The detection section 18 can also be arranged to detect the distance from the detection section 18 to the entering matter in accordance with the variation in the infrared ray. The control section 30 becomes to be capable of controlling the intensity of the light from the emission section 15 in accordance with the distance from the detection section 18 to the entering matter. For example, the control section 30 controls the intensity of the light so that the closer to the detection section 18 the position of the entering matter is, the more the intensity of the light is reduced. If the entering matter is located far from the detection section 18 with low possibility of occurrence of such a case as to exert uncomfortable feeling, the intensity of the light is reduced with a small variation.

As described above, which one of the measure for avoiding such a case as to exert uncomfortable feeling and continuation of the image display should be performed with priority can be determined based on the distance from the detection section 18 to the entering matter. Thus, occurrence of such a case as to exert uncomfortable feeling can be avoided while minimizing the influence on the image appreciation. Further, the control section 30 can be arranged to perform control for stopping supplying the light when the distance from the detection section 18 to the entering matter becomes smaller than a predetermined threshold value. Thus, occurrence of such a case as to exert uncomfortable feeling can more surely be avoided.

For example, the projector 10 decreases the intensity of the light when detecting that the entering matter enters an area within 1m from the emission section 15, and further, stops supplying the light when detecting that the entering matter enters an area within 50 cm from the emission section 15. The projector 10 can have a configuration of giving warning to the footer and so on as the entering matter with an alarm sound in conjunction with the control of the light. For example, when detecting that the entering matter enters the area within 1 m from the emission section 15, the alarm sound is generated while decreasing the intensity of the light. Thus, calling attention to entrance in the monitoring area AR1, occurrence of such a case as to exert uncomfortable feeling can surely be avoided.

The detection section 18 can be provided with a direction sensing function for detecting the proceeding direction of the entering matter in accordance with the variation in the infrared ray distribution. The control section 30 can be arranged to have variations in the control of the intensity of the light from the emission section 15 in accordance with the proceeding direction of the entering matter. For example, when the entering matter moves in a direction of getting closer to the emission section 15, the control section 30 performs control for rapidly decreasing the intensity of the light. Thus, occurrence of such a case as to exert uncomfortable feeling can more surely be avoided.

By using the infrared sensor as the detection section 18, entrance of the entering matter can be detected with a simple configuration. The detection section 18 can be a sensor other than infrared sensors. The detection section 18 can be what detects a variation in an electromagnetic radiation other than infrared rays. The electromagnetic radiation is preferably invisible light. As the detection section 18, besides what detects a variation in an electromagnetic radiation, an imaging device or an ultrasonic sensor, for example, can also be used. As the imaging device, a CCD sensor or a CMOS sensor can be used. In the case in which the imaging device is used, entrance of, the entering matter can be detected in accordance with a variation of the image. The distance from the imaging device to the entering matter can be detected in accordance with a rate of the variation of the image. The proceeding direction of the entering matter can be detected based on the moving direction of the image. By detecting the entrance of the entering matter, accurate detection becomes possible.

The ultrasonic sensor can be used together with an ultrasonic wave generation section. The ultrasonic sensor detects an ultrasonic wave generated from the ultrasonic wave generation section. When the entering matter enters the monitoring area AR1, the ultrasonic wave is reflected by the entering matter. The entrance of the entering matter can be detected in accordance with a variation in the ultrasonic wave detected by the ultrasonic sensor. The distance from the ultrasonic sensor to the entering matter can be detected in accordance with a rate of the variation in the ultrasonic wave. The proceeding direction of the entering matter can be detected in accordance with the variation in ultrasonic wave distribution. In the case in which the ultrasonic sensor is used, accurate detection with few false operations caused by the influence of the projection light, the ambient surrounding, and so on becomes possible.

By using a laser as each of the colored light source sections 21R, 21G, and 21B (see FIG. 2), the projector 10 can achieve high efficiency, high luminance, and high chromaticness. Even in the case in which a high power laser is used, the projector 10 can surely avoid occurrence of such a case as to exert uncomfortable feeling. The projector 10 is not limited to the case of using lasers as the light source sections. As each of the light source sections, for example, a solid-state light source such as an LED, or a lamp such as a super high pressure mercury, lamp can also be used. Further, the projector 10 can be a laser projector for scanning a laser beam modulated in accordance with the image signal. In the case with the laser projector, there are used a laser source for supplying the laser beam modulated in accordance with the image signal and a scanning optical system for scanning the beam from the laser source instead of the optical engine 12.

### Second Embodiment

FIG. 10 shows a perspective configuration of a projector 40 according to a second embodiment of the invention. A projector 40 according to the present embodiment has a feature of including a first detection section 41 and a second detection section 42. The same parts as in the first embodiment are denoted with the same reference numerals, and the duplicated explanations will be omitted. The first and second detection sections 41, 42 are detection sections for detecting an entering matter. The first and second detection sections 41, 42 are, for example, infrared sensors. The first and second detection sections 41, 42 can also be what detect a variation in an electromagnetic radiation other than the infrared ray, an imaging device, or an ultrasonic sensor, for example. The first and second detection sections 41, 42 are respectively disposed at an upper right end and an upper left end of the housing 17 on the side opposite to the side of the extended surface S1 (see FIG. 1). The first and second detection section 41, 42 are respectively disposed at different positions from each other in a horizontal plane substantially perpendicular to the extended surface S1.

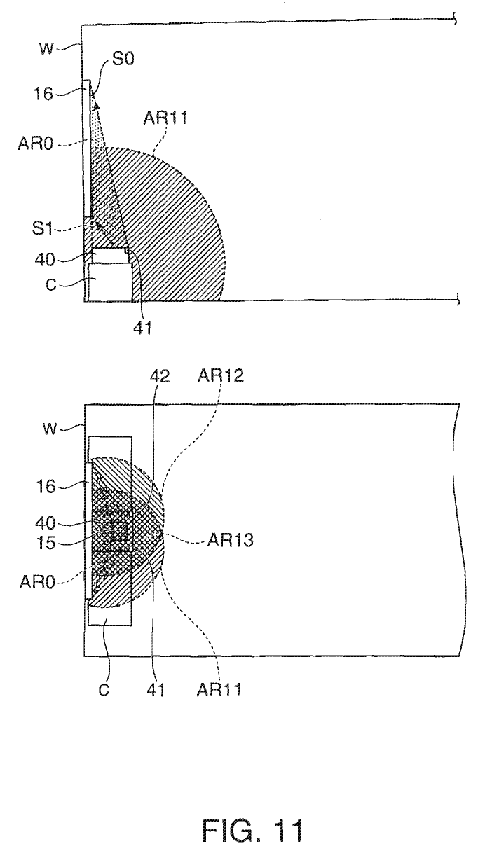

FIG. 11 is a diagram for explaining a first monitoring area AR11 of the first detection section 41 and a second monitoring area AR12 of the second detection section 42. The projector 40 is disposed so that a distance from the extended surface S1 to the center point of the emission section 15 is about 30 cm. The first detection section 41 monitors entrance of the entering matter in the first monitoring area AR11. The first monitoring area AR11 is a spatial domain having a shape similar to a sphere centered on the first detection section 41. The second detection section 42 monitors entrance of the entering matter in the second monitoring area AR12. The second monitoring area AR12 is a spatial domain having a shape similar to a sphere centered on the second detection section 42. By providing the first and second detection sections 41, 42 respectively at the right end and the left end of the housing 17, the monitoring area on the left and right of the projector 10 can be expanded. Thus, the projector 10 can sufficiently detect entrance of the entering matter from the sides thereof.

By providing the first and second detection sections 41, 42 to the upper part of the housing 17, monitoring in the upper side of the projector 10, and further, in an area in the vicinity of the screen 16 becomes possible. The first and second monitoring areas AR11, AR12 each include not only an area on the side opposite to the extended surface S1 with respect to the emission section 15 but also an area on the side of the extended surface S1 with respect to the emission section 15. The first and second detection section 41, 42 detect the entering matter entering the inside of the monitoring areas AR11, AR12 straddling both the side opposite to the extended surface S1 with respect to the emission section 15 and the side of the extended surface S1 with respect to the emission section 15. By performing the monitoring not only in the side opposite to the extended surface S1 but in the side of the extended surface S1 with respect to the emission section 15, further high reliability can be obtained.

Further, the first and second detection sections 41, 42 have the first and second monitoring areas AR11, AR12 overlap each other in a predetermined area AR13 in the vicinity of the emission section 15. The closer to the emission section 15 the, entering matter enters, the higher the probability of occurrence of such a case as to exert uncomfortable feeling becomes. By making the monitoring areas AR11, AR12 overlap each other in the vicinity of the emission section 15, it becomes possible to detect entrance of the entering matter into the area AR13 in the vicinity of the emission section 15 with high accuracy. As described above, the projector 40 can further surely avoid occurrence of such a case as to exert uncomfortable feeling by the first and second detection sections 41, 42.

It should be noted that the projector 40 is not limited to the configuration having the first and second detection sections 41, 42 at the positions explained in the present embodiment. It is sufficient for the first and second detection sections 41, 42 to be disposed at positions different from each other in horizontal directions. Thus, the entering matter can be detected in a large area in horizontal directions. The distance from the extended surface S1 to the center point O of the emission section 15 can be set to at least no larger than 80 cm, and appropriately in a range of about 30 through 40 cm.

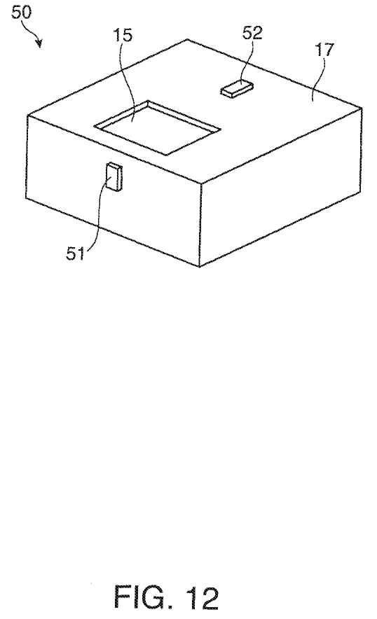

FIG. 12 shows a perspective configuration of a projector 50 according to a modified example of the second embodiment. A first detection section 51 of a projector 50 according to the present modified example is disposed on the housing 17 on the side opposite to the side of the extended surface S1 (see FIG. 1) similarly to the detection section 18 (see FIG. 1) of the first embodiment. A second detection section 52 is disposed on the housing 17 on the side the extended surface S1 with respect to the emission section 15. The first and second detection sections 51, 52 are detection sections for detecting an entering matter. The first and second detection sections 51, 52 are, for example, infrared sensors. The first and second detection sections 51, 52 can also be what detect a variation in an electromagnetic radiation other than the infrared ray, an imaging device, or an ultrasonic sensor, for example.

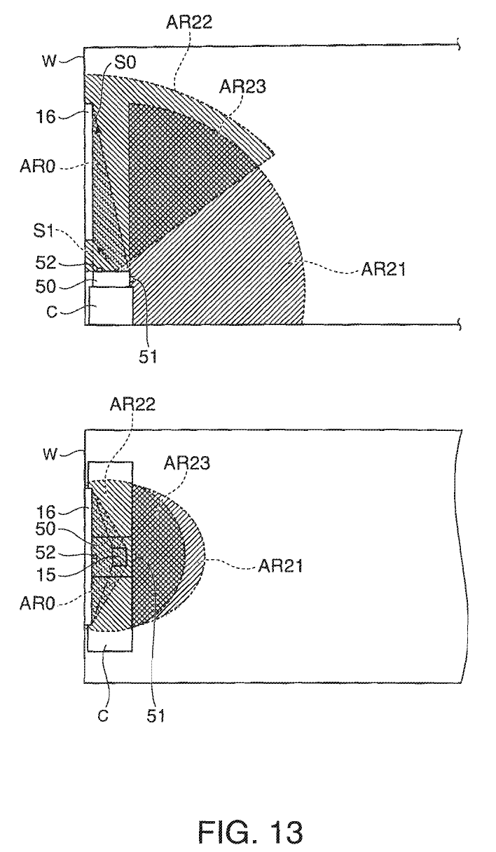

FIG. 13 is a diagram for explaining a first monitoring area AR21 of the first detection section 51 and a second monitoring area AR22 of the second detection section 52. The first monitoring area AR21 is substantially the same as the monitoring area AR1 (see FIG. 6) by the defection section 18 in the above embodiment. The first monitoring area AR21 includes an area on the side opposite to the side of the extended surface S1 with respect to the emission section 15. The first detection section 51 detects an entering matter on the side opposite to the side of the extended surface S1 with respect to the emission section 15. The second monitoring area AR22 includes the both areas above the projector 50 and respectively on the side opposite to the side of the extended surface S1 and the side of the extended surface S1 with respect to the emission section 15. The second detection section 52 detects the entering matter in an area above the projector 50 and mainly on the side of the extended surface S1 with respect to the emission section 15.

The projector 50 can be arranged to monitor both of the areas on the side opposite to the side of the extended surface S1 and the side of the extended surface S1 with respect to the emission section 15 by the first and second detection sections 51, 52. Further, the first and second monitoring areas AR21, AR22 overlap each other in a predetermined area AR23 on the observer side and above the projector 50. Therefore, it becomes possible to detect entrance of the entering matter in the area AR23 on the observer side and above the projector 50 with high accuracy. According to the above, also in the present modified example, occurrence of such a case as to exert uncomfortable feeling can more surely be avoided. For example, it can be arranged that the projector 50 stops supplying the light when the second detection section 52 detects the entering matter, or decreases the intensity of the light when only the first detection section 51 detects the entering matter. Thus, occurrence of such a case as to exert uncomfortable feeling can be avoided while minimizing the influence on the image appreciation.

It should be noted that the projector 50 is not limited to the configuration having the first and second detection sections 51, 52 at the positions explained in the present modified example. It is sufficient for the first detection section 51 to be able to detect the entering matter on the side opposite to the side of the extended surface S1 with respect, to the emission section 15. It is sufficient for the second detection section 52 to be able to detect the entering matter on the side of the extended surface S1 with respect to the emission section 15. Thus, it can be arranged to monitor both of the side opposite to the side of the extended surface S1 and the side of the extended surface S1 with respect to the emission section 15.

### Third Embodiment

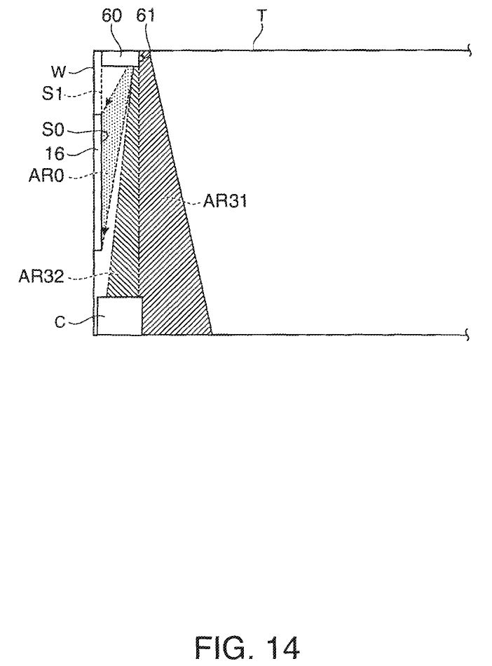

FIG. 14 is a diagram for explaining a projector 60 according to a third embodiment of the invention. The same parts as in the first embodiment are denoted with the same reference numerals, and the duplicated explanations will be omitted. The projector 60 has a configuration obtained by turning the projector 10 (see FIG. 1) of the first embodiment described above upside down. The projector 60 is disposed suspended from the ceiling surface T. The projector 60 performs close-up projection from a position opposed to the extended surface S1 and above the screen 16.

A detection section 61 is provided to the housing on the side opposite to the side of the extended surface S1. The detection section 61 is, for example, an infrared sensor. The detection section 61 can also be what detect a variation in an electromagnetic radiation other than the infrared ray, an imaging device, or an ultrasonic sensor, for example. The detection section 61 detects an entering matter entering a first and second monitoring areas AR31, AR32 as predetermined areas below the projector 60. Out of these areas, the first monitoring area AR31 on the side opposite to the side of the screen 16 with respect to the detection section 61 includes the side opposite to the side of the extended surface S1 with respect to the emission section. The second monitoring area AR32 on the side of the screen 16 from the detection section 61 includes the side of the extended surface S1 with respect to the emission section.

According to the present embodiment, the intensity of the light can be controlled when the entering matter enters an area below the projector 60 prior to the entering matter reaching the projection area AR0. Thus, occurrence of such a case as to exert uncomfortable feeling can surely be avoided. The projector 60 is not limited to the configuration of disposing the detection section 61 at the position explained in the present embodiment. It is sufficient to be able to detect entrance of the entering matter in the area below the projector 60.

As described hereinabove, the projector according to each of the embodiments of the invention is suitable for the case of performing the close-up projection.

The entire disclosure of Japanese Patent Application NO. 2006-327890, filed Dec. 5, 2006 is expressly incorporated by reference herein.

What is claimed is:

1. A projector comprising:
a projection engine section for projecting light corresponding to an image signal toward an irradiated surface;
a housing for housing the projection engine section, the housing including an emission section for projecting the light corresponding to the image signal from the projection engine section towards the irradiated surface;
a detection section for detecting an entering matter entering at least a monitoring area on a side opposite to a side of an extended surface of the irradiated surface with respect to the emission section; and
a control section for controlling intensity of light to be emitted from the emission section in accordance with a detection result of the detection section.

2. The projector according to claim 1,
wherein the projector is disposed at a position where a distance from the extended surface to a center point of the emission section is no greater than 80 cm.

3. The projector according to claim 1,
wherein the detection section is disposed on a surface of the housing on a side opposite to a side of the extended surface.

4. The projector according to claim 1,
wherein the emission section is disposed at a position shifted from a center of the housing to a side opposite to a side of the extended surface.

5. The projector according to claim 1,
wherein the detection section detects a variation in an electromagnetic radiation.

6. The projector according to claim 5, further comprising
an electromagnetic radiation generation section for generating the electromagnetic radiation.

7. The projector according to claim 1,
wherein the detection section detects a distance from the detection section to the entering matter, and
the control section controls the intensity of the light to be emitted from the emission section in accordance with the distance from the detection section to the entering matter.

8. The projector according to claim 1,
wherein the detection section includes
a first detection section, and
a second detection section disposed at a different position from a position of the first detection section in a horizontal plane substantially perpendicular to the extended surface.

9. The projector according to claim 8,
wherein the first detection section monitors entrance of the entering matter in a first monitoring area,
the second detection section monitors entrance of the entering matter in a second monitoring area, and
the first and second detection sections have the first and second monitoring areas overlap each other in the vicinity of the emission section.

10. The projector according to claim 1,
wherein the detection section detects an entering matter entering a monitoring area on a side of the extended surface with respect to the emission section.

11. The projector according to claim 10,
wherein the detection section includes
a first detection section for detecting the entering matter on the side opposite to the side of the extended surface with respect to the emission section, and
a second detection section for detecting the entering matter in the side of the extended surface with respect to the emission section.

12. The projector according to claim 1,
wherein the detection section monitors only the entrance of the entering matter in an area on a side opposite to a side of the extended surface with respect to the emission section.
